(19) United States
(12) Patent Application Publication
(10) Pub. No.: US 2013/0081793 A1
(43) Pub. Date: Apr. 4, 2013

(54) HEAT SEPARATOR

(71) Applicant: Dan MEKLER, Jerusalem (IL)

(72) Inventor: Dan MEKLER, Jerusalem (IL)

(21) Appl. No.: 13/602,224

(22) Filed: Sep. 3, 2012

(30) Foreign Application Priority Data
Sep. 5, 2011 (IL) 214976

(51) Int. Cl. F28F 13/06

(52) U.S. Cl. CPC F28F 13/06
USPC 165/104.34; 95/31; 55/482

(57) ABSTRACT

A heat separator for generating a warmer gas and a cooler gas from a gas in equilibrium, comprising two filtering meshes separated by a channel.

### CROSS-REFERENCE TO RELATED APPLICATIONS

This application claims priority from Israel Patent Application No. 214976, filed 5 Sep. 2011, which is hereby incorporated in its entirety by reference.

### FIELD OF THE INVENTION

The present invention relates to heat transfer generally and more particularly to a heat separator for separating a gaseous fluid into a warmer gas and a cooler gas.

### BACKGROUND OF THE INVENTION

Maxwell's Demon, as it is commonly known today, was an imaginary experiment conceived by physicist James Clerk Maxwell in the late 19^{th} century in an attempt to contradict the Second Law of Thermodynamics. The Second Law of Thermodynamics states that “in all energy exchanges, if no energy enters or leaves the system, the potential energy of the state will always be less than that of the initial state” (www.emc.maricopa.edu). This condition is generally associated with “entropy” which is a term frequently used to describe a tendency towards equilibrium, that is, a measure of how evenly energy is distributed throughout a system. An example of the Second Law of Thermodynamics and entropy may be seen in the phenomena that heat always flows from a warmer area to a cooler area in an attempt to reach a same temperature in both areas, and never flows in the opposite direction.

In Maxwell's experiment, a container full of air is divided into two chambers A and B with a small opening connecting the two chambers. The air in both chambers is in equilibrium but as is known in nature contains faster and slower travelling molecules. A “demon” controls opening and closing of the opening and watches the speed of the air molecules inside the chambers. Faster travelling molecules in chamber B approaching the opening are allowed through into chamber A by the demon while slower molecules are turned away and remain in chamber B. Molecules with slower speeds in chamber A approaching the opening are allowed through into chamber B by the demon while faster molecules are turned away and remain in chamber A. As a result, the number of faster molecules in chamber A increases, increasing the average molecular speed in the chamber, and the number of slower molecules in chamber B increases, decreasing the average molecular speed in the chamber. Since average molecular speed is associated with temperature, the temperature of the air inside chamber A increases while that in chamber B decreases. This result, according to Maxwell, contradicts the Second Law of Thermodynamics, as one chamber heats up as the other cools down, thus decreasing entropy.

Attempts have been made to apply the principles of Maxwell's Demon of taking a gas in equilibrium and dividing it into a hotter gas and a colder gas. An example of such an apparatus is described in U.S. Pat. No. 1,952,281 to Georges Joseph Ranque, “METHOD AND APPARATUS FOR OBTAINING FROM A FLUID UNDER PRESSURE TWO CURRENTS OF FLUIDS AT DIFFERENT TEMPERATURES”. Another apparatus is the Ranque-Hilsch vortex tube, or more commonly known as the vortex tube, which is a modification by a German physicist Rudolf Hilsch of the apparatus described by Ranque.

### SUMMARY OF THE PRESENT INVENTION

There is provided, in accordance with an embodiment of the present invention, a heat separator for generating a warmer gas and a cooler gas from a gas in equilibrium comprising two filtering meshes separated by a channel.

In accordance with an embodiment of the present invention, each of the filtering meshes includes an antistatic material.

In accordance with an embodiment of the present invention, each of the filtering meshes includes openings in a size range of 10μ-150μ.

In accordance with an embodiment of the present invention, each of the filtering meshes includes openings covering between 20%-50% of the mesh's surface area.

In accordance with an embodiment of the present invention, the channel is of a width between 0.5 mm to 2 mm.

In accordance with an embodiment of the present invention, the gas is air.

There is provided, in accordance with an embodiment of the present invention, a cooling/heating unit comprising at least two filtering meshes separated by a channel; a blower for blowing a gas in equilibrium into the channel; and at least one of an outlet for warmer gas from within the channel and an outlet for cooler gas from outside of the channel.

In accordance with an embodiment of the present invention, each of the at least two filtering meshes includes an antistatic material.

In accordance with an embodiment of the present invention, each of the at least two filtering meshes includes openings in a size range of 10μ-150μ.

In accordance with an embodiment of the present invention, each of the at least two filtering meshes includes openings covering between 20%-50% of the mesh's surface area.

In accordance with an embodiment of the present invention, the channel has a width between 0.5 mm and 2 mm.

There is provided, in accordance with an embodiment of the present invention, a method of separating a gaseous fluid in equilibrium into a cooler gas and a warmer gas comprising blowing the gaseous fluid into a channel separating two filtering meshes.

In accordance with an embodiment of the present invention, the method further comprises passing slower molecules in the gaseous fluid through at least one of the two filtering meshes.

In accordance with an embodiment of the present invention, the method further comprises conducting the slower molecules through an outlet for cooler gas.

In accordance with an embodiment of the present invention, the method further comprises passing faster molecules in the gaseous fluid through the channel.

In accordance with an embodiment of the present invention, the method further comprises conducting the faster molecules through an outlet for warmer gas.

In accordance with an embodiment of the present invention, the gaseous fluid is blown into the channel at a velocity ranging from 0.1 m/sec-3 m/sec.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a cross-sectional view of an exemplary heat separator, according to an embodiment of the present invention;

FIG. 2 is a cross-sectional view of an exemplary heat separating unit, according to an embodiment of the present invention;

FIG. 3 is a block diagram of an exemplary heating/cooling unit, according to some embodiments of the present invention; and

FIG. 4 is a picture illustrating a prototype heating/cooling unit, according to an embodiment of the present invention; and

FIG. 5 is a picture illustrating temperature readings taken of the warmer gas and the cooler gas produced by the prototype heating/cooling unit of FIG. 4, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has discovered that a gaseous fluid in a state of equilibrium, for example air, may be separated into a warmer gas and a cooler gas by forcing the gaseous fluid at a relatively high speed through a thin channel formed between two filtering meshes. The warmer gas and the cooler gas may be generated by causing at least a portion of the slower moving molecules in the gaseous fluid to pass through the meshes and out of the channel as the gaseous fluid flows through the channel. The slower molecules passing through the meshes may form a gas with a lower average molecular speed and therefore, a lower temperature and a cooler gas. The gas flowing out of the channel, which may now be partially or wholly depleted of slower molecules, may have a relatively larger number of faster molecules and so an increased average molecular speed, and therefore a higher temperature and a warmer gas.

The Applicant's “heat separator” provides a potential solution for separating gaseous fluids into warmer and cooler gases, a problem posed by Maxwell through his imaginary Maxwell's Demon. Attempts to solve this problem have been mostly unsuccessful, the vortex tube possibly being the only other known successful attempt, but from a completely different aspect, and possibly for different applications.

The Applicant has further discovered that some, if not all, of the slower molecules which have been depleted from the gaseous fluid through the two filtering meshes generally do not reenter into the rapidly flowing gaseous fluid inside the channel. This condition may allow connecting a plurality of heat separators in parallel to form a heat separation unit capable of generating temperature differences of up to 35° C. between the cooler air and the warmer air, as measured by the Applicant during testing of an experimental prototype.

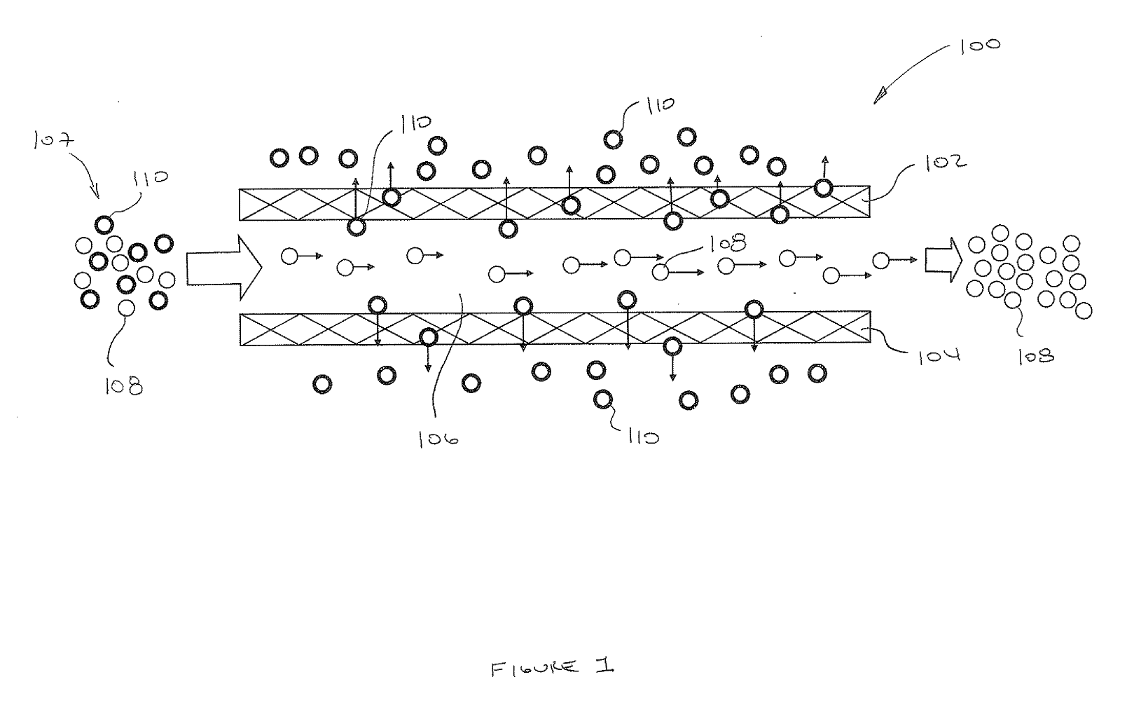

Reference is now made to FIG. 1 which is a cross-sectional view of an exemplary heat separator 100, according to an embodiment of the present invention. Heat separator 100 includes a first filtering mesh 102, a second filtering mesh 104, and a channel 106 separating the filtering meshes.

According to an exemplary embodiment of the present invention, heat separator 100 may be configured to separate a relatively fast flowing gaseous fluid 107 in equilibrium flowing through channel 106, for example air, into a cooler gas and a warmer gas. A velocity of the flowing gas may be in the range from 0.1 m/sec-3 m/sec, for example, 0.2 m/sec, 0.5 m/sec, 0.8 m/sec, 1.1 m/sec, 1.5 m/sec, 1.8 m/sec, 2 m/sec, 2.2 m/sec, 2.7 m/sec, 3 m/sec. A pressure of the flowing gas may be in the range from 0.1 kg/cm²-5 kg/cm², for example, 0.1 kg/cm², 0.2 kg/cm², 0.25 kg/cm², 0.3 kg/cm², 0.4 kg/cm², 0.5 kg/cm², 0.8 kg/cm², 1.0 kg/cm², 1.0 kg/cm², 1.2 kg/cm², 1.5 kg/cm², 1.9 kg/cm², 2.0 kg/cm², 2.2 kg/cm², 2.5 kg/cm², 2.8 kg/cm², 3.0 kg/cm², 3.5 kg/cm², 4.0 kg/cm², 4.5 kg/cm², 4.8 kg/cm². The cooler gas may include a plurality of slower molecules 110 which pass through filtering meshes 102 and 104 as gaseous fluid 107 flows through channel 106. The cooler gas may be made up only of slower molecules 110, or may include faster molecules 108 which manage to pass through filtering meshes 102 and 104 although proportionately in less amounts than the slower molecules. The warmer gas may include faster molecules 108 flowing out of channel 106 following depletion of all slower molecules 110 through filtering meshes 102 and 104, or may include a mixture of the faster molecules and the slower molecules following partial depletion of the slower molecules through the filtering meshes. The mixture of faster molecules 108 and slower molecules 110 flowing out of channel 106 may have an increased number of the faster molecules compared to the slower molecules.

According to an exemplary embodiment of the present invention, channel 106 may separate filtering mesh 102 from filtering mesh 104 by a distance ranging from 0.3 mm-3 mm for example, 0.5 mm, 1 mm, 1.5 mm, 2 mm, 2.5 mm Filtering mesh 102 and 104 may be made from any suitable antistatic material and/or may include an antistatic coating. A hole size of filtering mesh 102 and 104 may range from 10μ-150μ, for example 15μ, 20μ, 30μ, 40μ, 50μ, 70μ, 80μ, 100μ, 120μ, 140μ. A total opening (hole) area in filtering mesh 102 and 104 may range from 10%-70%, for example, 30%, 35%, 45%, 50%, 55%, 60%, 65%. In some exemplary embodiments of the present invention, filtering mesh 102 and 104 may be adapted to resist a gas pressure of 3-5 kg/cm², for example, 3.2 kg/cm², 3.5 kg/ cm², 4 kg/cm², 4.5 kg/cm², 4.8 kg/cm². Filtering mesh 102 and/or filtering mesh 104 may include a single mesh layer or alternatively, may include a plurality of mesh layers placed one on the other, for example, 2 layers, 3 layers, 4 layers, 5 layers, or more. Additionally or alternatively, filtering mesh 102 and 104 may have the same physical characteristics (e.g. hole size, total opening surface area) or may have different physical characteristics, for example, filtering mesh 102 may have openings of 100μ and filtering mesh 104 may have openings of 140μ.

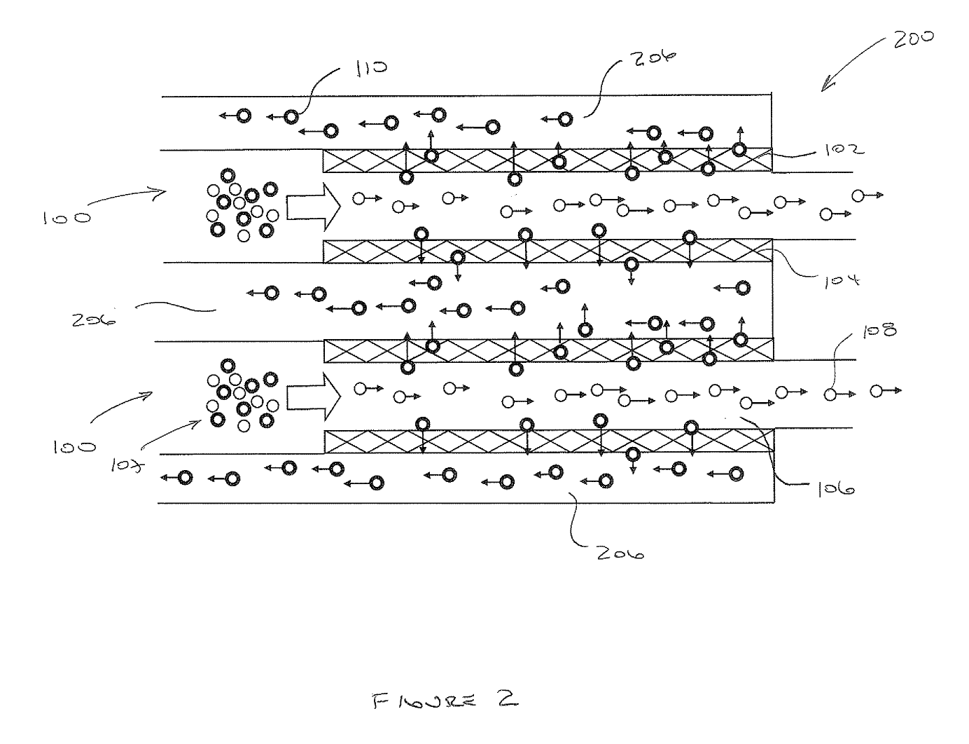

Reference is now made to FIG. 2 which is a cross-sectional view of an exemplary heat separating unit 200, according to an embodiment of the present invention. Heat separating unit 200 includes two heat separators 100 arranged in a parallel configuration. In some exemplary embodiments of the present invention. heat separating unit 200 may include one heat separator 100, or more than two heat separators, for example, 3, 4, 5, 10, 20, 30, 50, 100, 150, 200, 300, 500, 1000, 2000, 5000, 10000, or more, connected in parallel, in series, or any combination thereof.

Heat separating unit 200 is adapted to generate a warmer gas and a colder gas from a fast moving gas 107 in equilibrium, by separating faster molecules 108 from slower molecules 110 in each heat separator 100. The warmer gas flows out of channel 106 in each heat separator and may directed so that all the generated warmer gas maybe collected together. Slower molecules 110 pass through filtering meshes 102 and 104 in each heat separator 100 into a conduit 206 through which the cooler gas flows. Conduits 206 may be directed so that all the generated cooler air may be collected together.

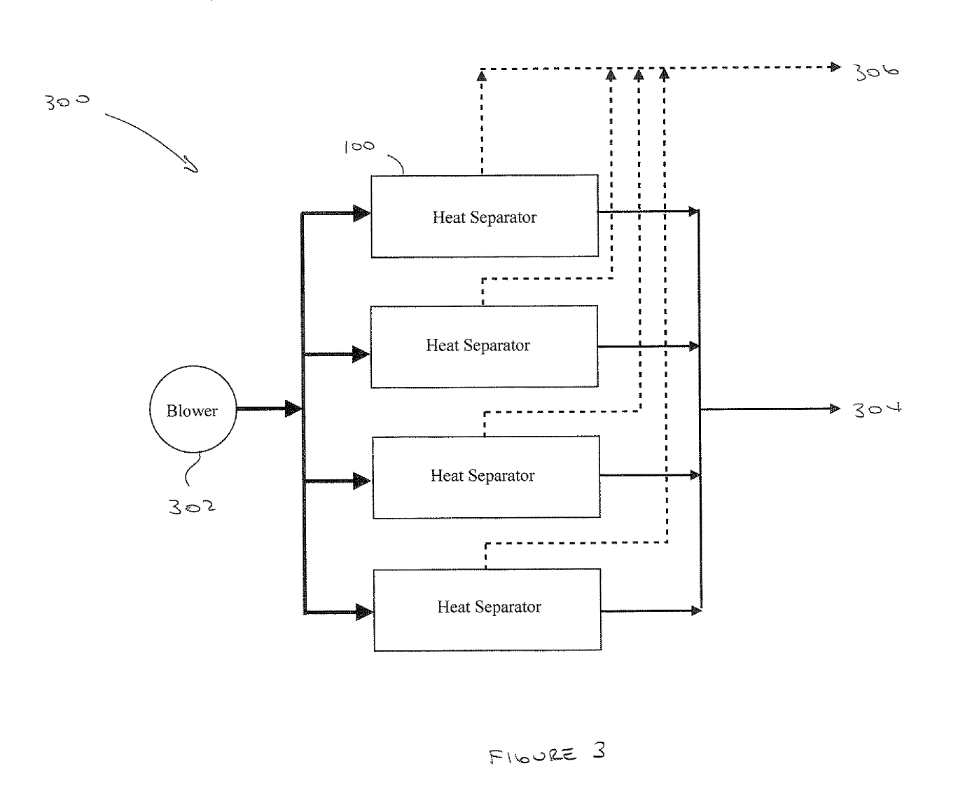

Reference is now made to FIG. 3 which is a block diagram of an exemplary heating/cooling unit 300, according to some embodiments of the present invention. Heating/cooling unit 300 may include a blower 302 adapted to speed up a gas in equilibrium, and one or more heat separators 100 connected in parallel and/or in series. Heating/cooling unit 300 is configured to produce a warmer gas 304 and a cooler gas 306 from the fast moving gas. Blower 302 may be configured to speed up the gas to a velocity from 0.1 m/sec-3 m/sec, for example, 0.2 m/sec, 0.5 m/sec, 0.8 m/sec, 1.1 m/sec, 1.5 m/sec, 1.8 m/sec, 2 m/sec, 2.2 m/sec, 2.7 m/sec, 2.9 m/sec. Heating/cooling unit may include an air conditioning unit, a heater unit, or any other type of equipment suitable for heating and/or cooling inside stationary structures and vehicles. Some additional applications may include using heating/cooling unit 300 as a cooling unit for a motorcycle helmet, or as a heater for a boiler.

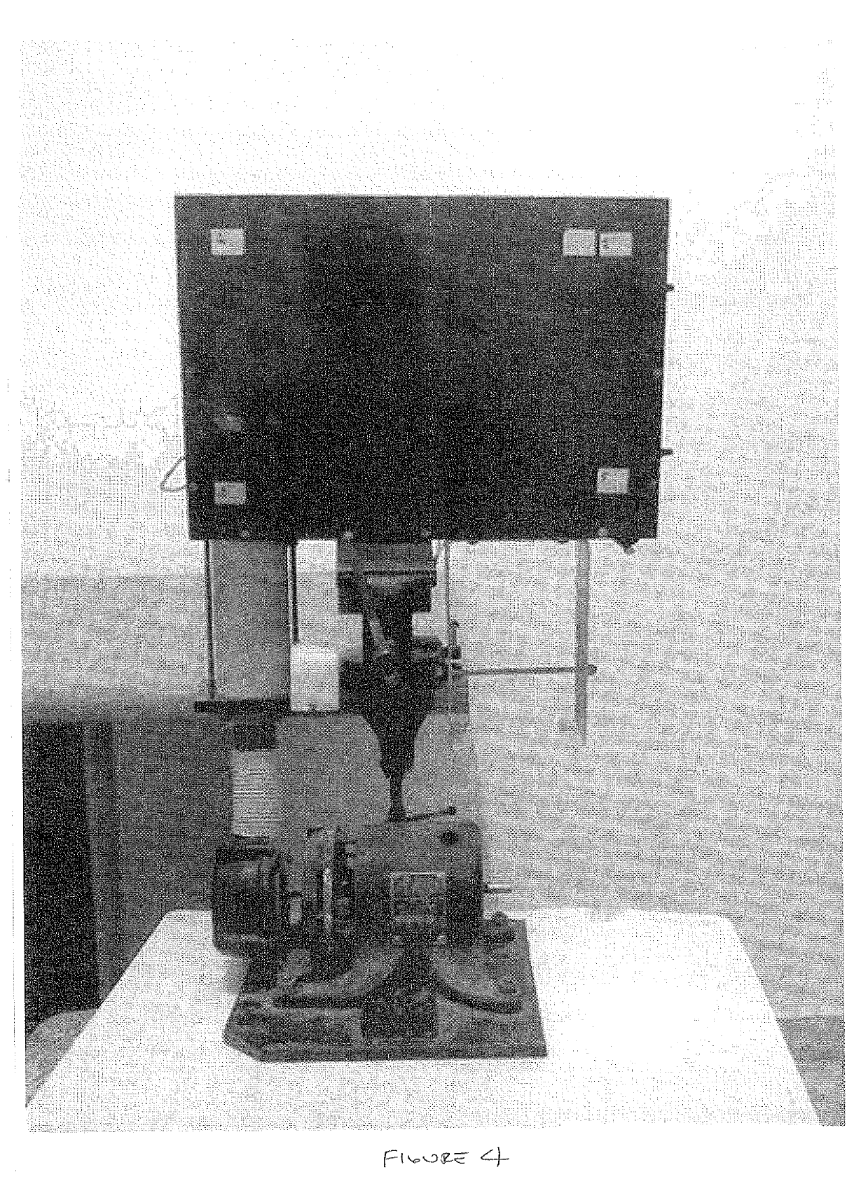

The Applicant conducted tests on a prototype heating/cooling unit according to an embodiment of the present invention and shown in FIG. 4. The heating/cooling unit included 90 filtering meshes in parallel having openings of 50μ. The dimensions of the filtering meshes were 50 mm wide by 250 mm length. Channel width between the filtering meshes ranged between 1-1.5 cm. The gas used was flowing air which sped up by a 50 W fan domestic fan.

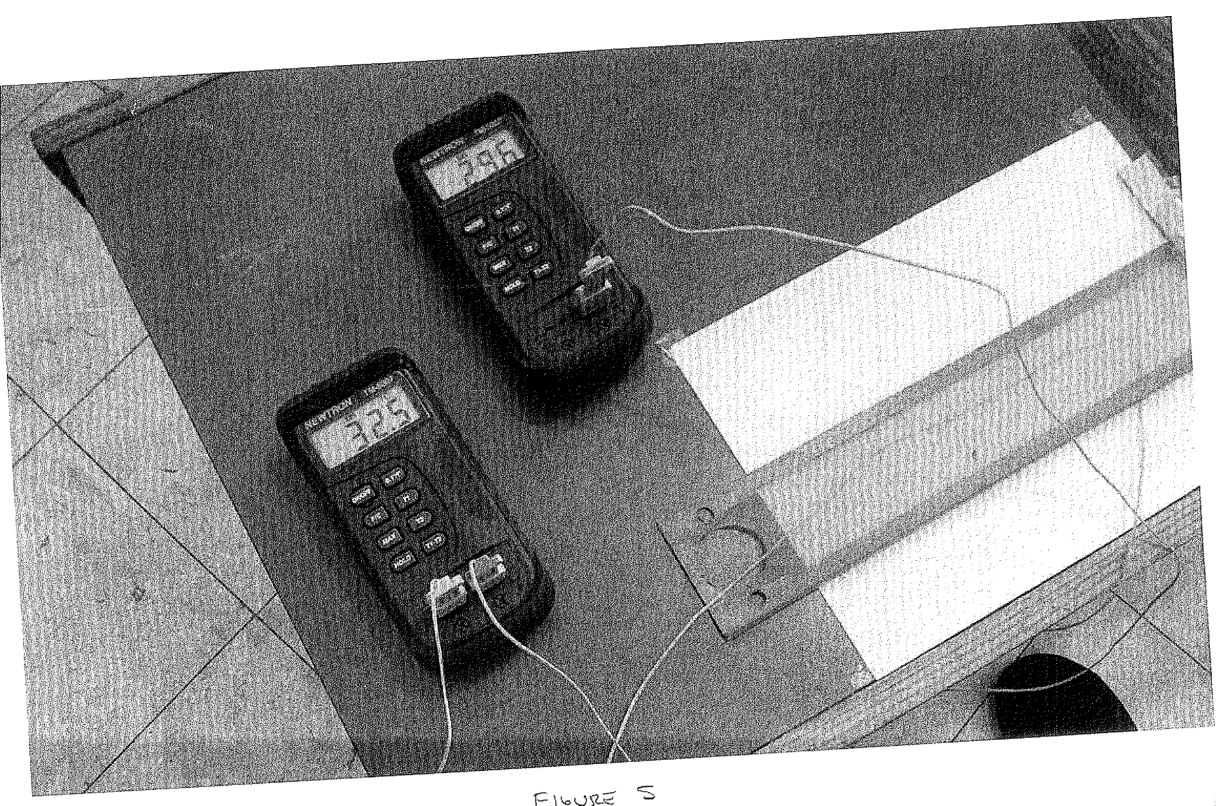

At a room temperature of 18° C., a difference in temperature of 4°-8° C. was measured between the warmer gas and the cooler gas. When the air was heated up to 70° C., a difference in temperature of 35° C. was measured between the colder gas (35°) and the warmer gas (70°). Although tests were not conducted using longer filtering meshes, the Applicant believes that extending the length of the filtering meshes by another 100 mm-150 mm may increase the temperature difference by two, that is 70° C. Reference is also made to FIG. 5 which shows a temperature measurement of 32.5° C. for the warmer gas and 29.6° C. for the cooler gas, a difference of almost 3° C.

Additional testing was conducted using two filtering meshes of 300 mm length by 50 mm wide without an enclosure. The filtering meshes were made from polyester and had holes of 150μ. The room temperature was 28° C. and flowing air was supplied using the 50 W fan. A difference in temperature of approximately 6° C. was measured between the colder gas and the warmer gas, leading the Applicant to the conclusion that the longer the filtering meshes, the greater the temperature difference.

The previously disclosed velocity and pressure ranges, as well as ranges associated with channel dimensions, filtering mesh dimensions and filtering mesh characteristics, are provided by the Applicant for exemplary purposes and are not intended to be limiting. The ranges are provided based partially on experimental determination by the Applicant using a limited number of prototypes and under limited conditions, and are therefore not all-inclusive. Furthermore, the tests were conducted using air as the gaseous fluid and some or all of the ranges may vary for other types of gaseous fluids. For example, bottom range limits possibly may possibly be lesser and/or upper range limits possibly greater. Furthermore, range values may vary from those disclosed depending on the application of the heat separator and the heating/cooling unit. Some applications may include using the heat separator and heating/cooling unit at a micro scale and nano scale as applicable to micro-technology and nano-technology applications, and at a macro-scale as applicable for use in large structures (large vehicles and edifices).

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A heat separator for generating a warmer gas and a cooler gas from a gas in equilibrium comprising two filtering meshes separated by a channel.

2. A heat separator according to claim 1 wherein each said filtering mesh includes an antistatic material.

3. A heat separator according to claim 1 wherein each said filtering mesh includes openings in a size range of 10μ-150μ.

4. A heat separator according to claim 1 wherein each said filtering mesh includes openings covering between 20%-50% of the mesh's surface area.

5. A heat separator according to claim 1 wherein said channel is of a width between 0.5 mm and 2 mm.

6. A heat separator according to claim 1 wherein said gas is air.

7. A cooling/heating unit comprising:
at least two filtering meshes separated by a channel;
a blower for blowing a gas in equilibrium into said channel; and
at least one of an outlet for warmer gas from within said channel and an outlet for cooler gas from outside of said channel.

8. A cooling/heating unit according to claim 7 wherein each of said at least two filtering meshes includes an antistatic material.

9. A cooling/heating unit according to claim 7 wherein each of said at least two filtering meshes includes openings in a size range of 10μ-150μ.

10. A cooling/heating unit according to claim 7 wherein each of said at least two filtering meshes includes openings covering between 20%-50% of the mesh's surface area.

11. A cooling/heating unit according to claim 7 wherein said channel has a width between 0.5 mm and 2 mm.

12. A cooling/heating unit according to claim 7 wherein said gas is air.

13. A method of separating a gaseous fluid in equilibrium into a cooler gas and a warmer gas comprising blowing said gaseous fluid into a channel separating two filtering meshes.

14. A method according to claim 13 further comprising passing slower molecules in said gaseous fluid through at least one of said two filtering meshes.

15. A method according to claim 14 further comprising conducting said slower molecules through an outlet for cooler gas.

16. A method according to claim 13 further comprising passing faster molecules in said gaseous fluid through said channel.

17. A method according to claim 16 further comprising conducting said faster molecules through an outlet for warmer gas.

18. A method according to claim 13 wherein said gaseous fluid is blown into said channel at a velocity ranging from 0.1 m/sec-3 m/sec.
